(19) United States
(12) Patent Application Publication
(10) Pub. No.: US 2022/0047091 A1
(43) Pub. Date: Feb. 17, 2022

(54) Air Cushion Structure

(71) Applicant: FENG YI OUTDOOR LEISURE EQUIPMENT ENTERPRISE CO., LTD., Taichung City (TW)

(72) Inventor: Cindy Lin, Taichung City (TW)

(21) Appl. No.: 16/991,213

(22) Filed: Aug. 12, 2020

(51) Int. Cl. A47C 27/08; B32B 27/08; B32B 7/14; B32B 3/26; B32B 27/40

(52) U.S. Cl. CPC A47C 27/081; B32B 27/08; B32B 7/14; B32B 2479/00; B32B 27/40; A47C 27/087; B32B 3/266

(57) ABSTRACT

An air cushion structure includes an upper surface layer, an upper pull strap, an upper isolating layer, a lower isolating layer, a lower pull strap, and a lower surface layer. A plurality of upper air chambers are formed between the upper surface layer and the upper pull strap. A plurality of lower air chambers are formed between the lower pull strap and the lower surface layer. A plurality of middle air chambers are formed between the upper isolating layer and the lower isolating layer. Thus, the air cushion structure contains multiple air chambers to provide a better support, and to provide a warming effect.

### BACKGROUND OF THE INVENTION

### 1. Field of the Invention

The present invention relates to a cushion and, more particularly, to an air cushion structure.

### 2. Description of the Related Art

A conventional air cushion 50 in accordance with the prior art shown in FIGS. 11 and 12 comprises an upper layer 51, a lower layer 52, an air valve 55, and a plurality of pull straps 53. The upper layer 51 and the lower layer 52 are connected. The pull straps 53 are located between the upper layer 51 and the lower layer 52, and multiple air channels 54 are formed between the pull straps 53. The air channels 54 are connected to each other. Each of the pull straps 53 has a length less than that of the upper layer 51 and that of the lower layer 52. Thus, the two ends of the conventional air cushion 50 are open such that the air channels 54 are connected to form an air circulation. In such a manner, the interior of the conventional air cushion 50 is full of an air expansion layer such that the conventional air cushion 50 has an elastic feature to facilitate the user lying on the conventional air cushion 50. However, the air expansion layer in the conventional air cushion 50 does not have an enough warming effect. In addition, the air expansion layer of the conventional air cushion 50 only contains a single air chamber so that when the user lies on the conventional air cushion 50, the pressure is totally supported by the single air chamber, and is not distributed evenly over the conventional air cushion 50. Thus, the conventional air cushion 50 cannot support a larger pressure.

### BRIEF SUMMARY OF THE INVENTION

The primary objective of the present invention is to provide an air cushion structure that provides a better support and a warming effect.

In accordance with the present invention, there is provided an air cushion structure comprising an upper surface layer, an upper pull strap, an upper isolating layer, a lower isolating layer, a lower pull strap, and a lower surface layer. The upper surface layer is provided with a plurality of upper adhering points which are equally distant from each other. The upper surface layer is provided with an air valve. The upper pull strap is mounted on a bottom of the upper surface layer. The upper pull strap is provided with a plurality of first adhering points and a plurality of second adhering points. The first adhering points are equally distant from each other. The second adhering points are equally distant from each other. The upper isolating layer is mounted on a bottom of the upper pull strap. The upper isolating layer is provided with a plurality of third adhering points and a plurality of upper perforations. The lower isolating layer is mounted on a bottom of the upper isolating layer. The lower isolating layer has a bottom provided with a plurality of fourth adhering points. The lower isolating layer is provided with a plurality of lower perforations. The lower pull strap is mounted on a bottom of the lower isolating layer. The lower pull strap is provided with a plurality of fifth adhering points and a plurality of sixth adhering points. The fifth adhering points are equally distant from each other. The sixth adhering points are equally distant from each other. The lower surface layer is mounted on a bottom of the lower pull strap. The lower surface layer is provided with a plurality of lower adhering points which are equally distant from each other.

According to the primary advantage of the present invention, the air cushion structure constructs multiple air chambers by provision of the upper pull strap and the lower pull strap and by provision of the upper isolating layer and the lower isolating layer, to provide obstruction and isolation functions, thereby preventing the cold air from directly touching the user, so as to achieve a warming effect efficiently.

According to another advantage of the present invention, the air cushion structure contains multiple air chambers so that when the user lies on the air cushion structure, the multiple air chambers distribute the pressure evenly, so as to provide a better support, and to provide a comfortable sensation to the user.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an air cushion structure in accordance with the preferred embodiment of the present invention.

FIG. 2 is an exploded perspective view of the air cushion structure in accordance with the preferred embodiment of the present invention.

FIG. 3 is a top view of an upper surface layer of the air cushion structure in accordance with the preferred embodiment of the present invention.

FIG. 4 is a bottom view of a lower surface layer of the air cushion structure in accordance with the preferred embodiment of the present invention.

FIG. 5 is a top view of an upper pull strap of the air cushion structure in accordance with the preferred embodiment of the present invention.

FIG. 6 is a bottom view of a lower pull strap of the air cushion structure in accordance with the preferred embodiment of the present invention.

FIG. 7 is a top view of an upper isolating layer of the air cushion structure in accordance with the preferred embodiment of the present invention.

FIG. 8 is a bottom view of a lower isolating layer of the air cushion structure in accordance with the preferred embodiment of the present invention.

FIG. 9 is a cross-sectional view of the air cushion structure taken along line A-A as shown in FIG. 1.

FIG. 10 is a locally enlarged view of the air cushion structure as shown in FIG. 9.

FIG. 11 is a perspective view of a conventional air cushion in accordance with the prior art.

FIG. 12 is a cross-sectional view of the air cushion structure taken along line B-B as shown in FIG. 11.

### DETAILED DESCRIPTION OF THE INVENTION

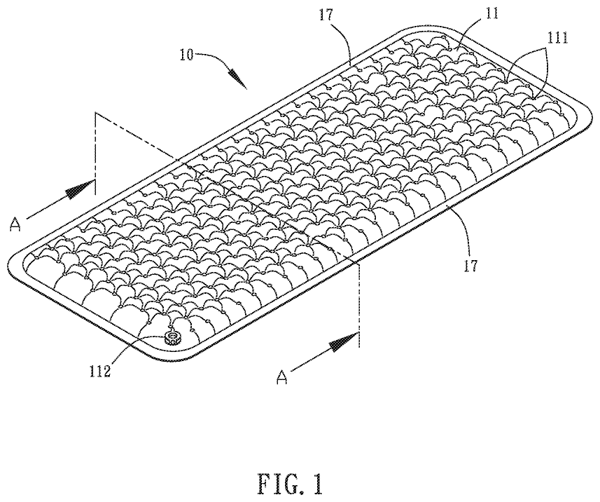

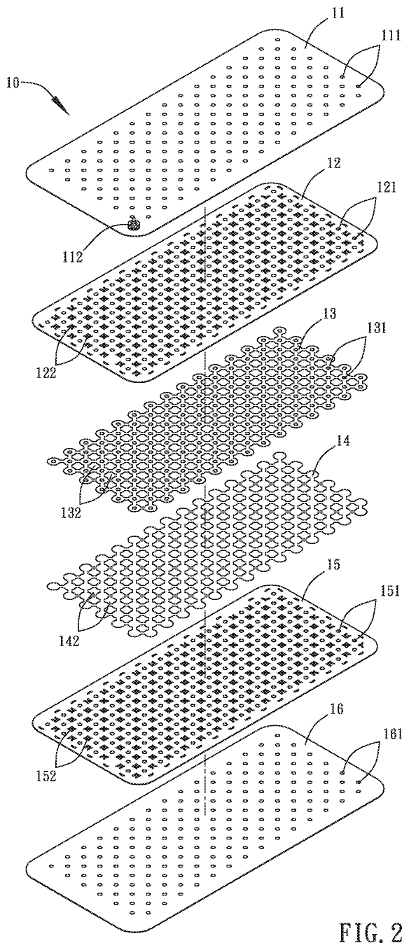

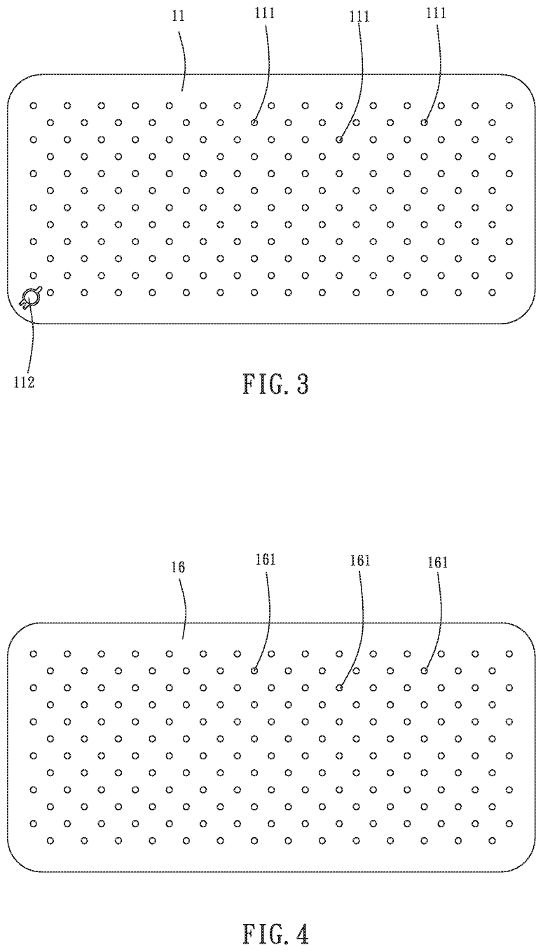

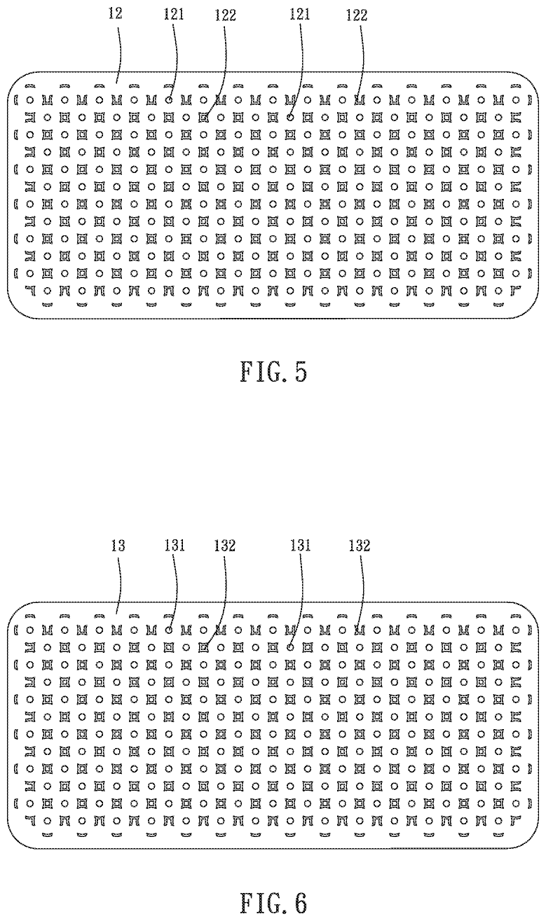

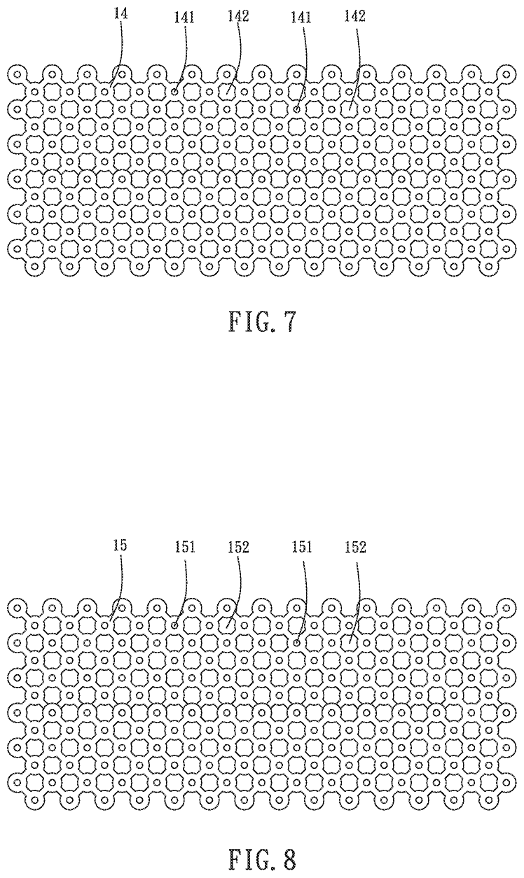

Referring to the drawings and initially to FIGS. 1-8, an air cushion structure 10 in accordance with the preferred embodiment of the present invention comprises an upper surface layer 11, an upper pull strap 12, an upper isolating (or separating) layer 13, a lower isolating (or separating) layer 14, a lower pull strap 15, and a lower surface layer 16.

The upper surface layer 11 is provided with a plurality of upper adhering points 111 which are equally distant from each other. The upper surface layer 11 is provided with an air valve 112.

The upper pull strap 12 is mounted on a bottom of the upper surface layer 11. The upper pull strap 12 is provided with a plurality of first adhering points 121 and a plurality of second adhering points 122. The first adhering points 121 are equally distant from each other. The second adhering points 122 are equally distant from each other.

The upper isolating layer 13 is mounted on a bottom of the upper pull strap 12. The upper isolating layer 13 is provided with a plurality of third adhering points 131 and a plurality of upper perforations 132.

The lower isolating layer 14 is mounted on a bottom of the upper isolating layer 13. The lower isolating layer 14 has a bottom provided with a plurality of fourth adhering points 141. The lower isolating layer 14 is provided with a plurality of lower perforations 142.

The lower pull strap 15 is mounted on a bottom of the lower isolating layer 14. The lower pull strap 15 is provided with a plurality of fifth adhering points 151 and a plurality of sixth adhering points 152. The fifth adhering points 151 are equally distant from each other. The sixth adhering points 152 are equally distant from each other.

The lower surface layer 16 is mounted on a bottom of the lower pull strap 15. The lower surface layer 16 is provided with a plurality of lower adhering points 161 which are equally distant from each other.

In the preferred embodiment of the present invention, the upper pull strap 12 and the lower pull strap 15 have an equal length and an equal width.

In the preferred embodiment of the present invention, the length and width of the upper pull strap 12 is less than that of the upper surface layer 11 and that of the lower surface layer 16, and the length and width of the lower pull strap 15 is less than that of the upper surface layer 11 and that of the lower surface layer 16.

In the preferred embodiment of the present invention, the upper adhering points 111 of the upper surface layer 11, the first adhering points 121 of the upper pull strap 12, and the third adhering points 131 of the upper isolating layer 13 correspond to each other and are connected together.

In the preferred embodiment of the present invention, the upper isolating layer 13 and the lower isolating layer 14 are disconnected when being heated. Preferably, the upper isolating layer 13 and the lower isolating layer 14 are made of an aluminum foil.

In the preferred embodiment of the present invention, the second adhering points 122 of the upper pull strap 12, the upper perforations 132 of the upper isolating layer 13, the lower perforations 142 of the lower isolating layer 14, and the sixth adhering points 152 of the lower pull strap 15 correspond to each other. The second adhering points 122 of the upper pull strap 12 and the sixth adhering points 152 of the lower pull strap 15 are connected together.

In the preferred embodiment of the present invention, the fourth adhering points 141 of the lower isolating layer 14, the fifth adhering points 151 of the lower pull strap 15, and the lower adhering points 161 of the lower surface layer 16 correspond to each other and are connected together.

In the preferred embodiment of the present invention, the upper surface layer 11 and the lower surface layer 16 have an equal length and an equal width.

In the preferred embodiment of the present invention, the bottom of the upper surface layer 11 is provided with an air impermeable plastic film that is made of thermoplastic polyurethane (TPU), the upper pull strap 12 is a plastic film that is made of thermoplastic polyurethane (TPU), the lower pull strap 15 is a plastic film that is made of thermoplastic polyurethane (TPU), and the lower surface layer 16 has a top provided with an air impermeable plastic film that is made of thermoplastic polyurethane (TPU).

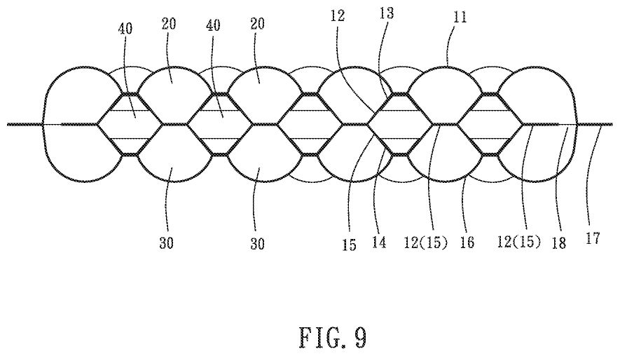

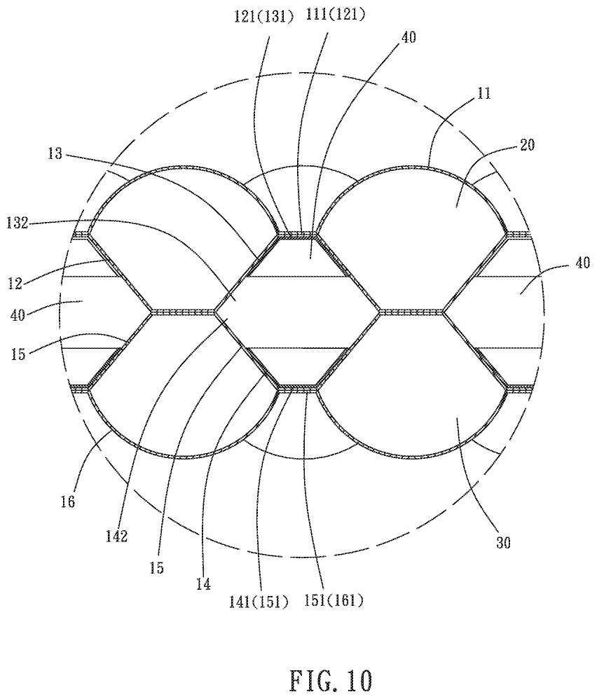

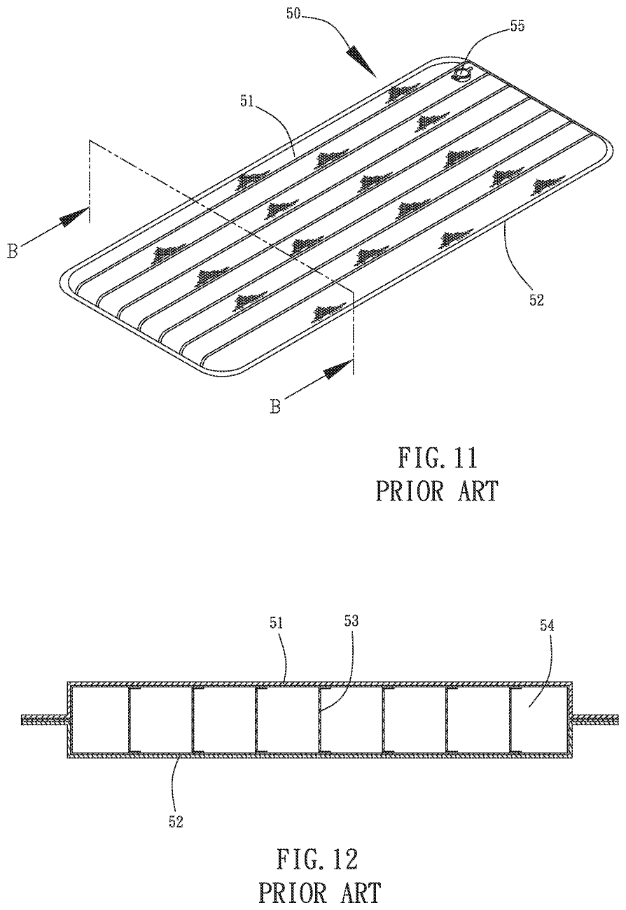

In assembly, referring to FIGS. 9 and 10 with reference to FIGS. 1-8, the upper pull strap 12, the upper isolating layer 13, the lower isolating layer 14, and the lower pull strap 15 are placed serially. Then, the upper pull strap 12, the upper isolating layer 13, the lower isolating layer 14, and the lower pull strap 15 are pressed and heated by a welding machine (or press), such that the second adhering points 122 of the upper pull strap 12 and the sixth adhering points 152 of the lower pull strap 15 are fused and bonded together by heat. At this time, the second adhering points 122 of the upper pull strap 12, the upper perforations 132 of the upper isolating layer 13, the lower perforations 142 of the lower isolating layer 14, and the sixth adhering points 152 of the lower pull strap 15 align with each other, such that the upper isolating layer 13 and the lower isolating layer 14 will not obstruct connection of the second adhering points 122 of the upper pull strap 12 and the sixth adhering points 152 of the lower pull strap 15. In such a manner, the upper isolating layer 13 and the lower isolating layer 14 are limited between the upper pull strap 12 and the lower pull strap 15.

Subsequently, the upper pull strap 12 and the lower pull strap 15 are placed between the upper surface layer 11 and the lower surface layer 16. Then, the upper surface layer 11 and the lower surface layer 16 are pressed and heated by the welding machine to seal and fuse the periphery 17 of the upper surface layer 11 and the lower surface layer 16, such that the upper adhering points 111 of the upper surface layer 11, the first adhering points 121 of the upper pull strap 12, and the third adhering points 131 of the upper isolating layer 13 are fused and bonded together by heat, while the fourth adhering points 141 of the lower isolating layer 14, the fifth adhering points 151 of the lower pull strap 15, and the lower adhering points 161 of the lower surface layer 16 are fused and bonded together by heat.

In such a manner, a plurality of upper air chambers 20 are formed between the upper surface layer 11 and the upper pull strap 12 by division of the upper adhering points 111 of the upper surface layer 11, the first adhering points 121 of the upper pull strap 12, and the third adhering points 131 of the upper isolating layer 13, and a plurality of lower air chambers 30 are formed between the lower pull strap 15 and the lower surface layer 16 by division of the fourth adhering points 141 of the lower isolating layer 14, the fifth adhering points 151 of the lower pull strap 15, and the lower adhering points 161 of the lower surface layer 16.

In addition, the upper isolating layer 13 and the lower isolating layer 14 are disconnected and separated from each other when being heated, such that a plurality of middle air chambers 40 are formed between the upper isolating layer 13 and the lower isolating layer 14.

When the air cushion structure 10 is in use, ambient air is introduced through the air valve 112 into the air cushion structure 10 to expand the air cushion structure 10. At this time, the length and width of the upper pull strap 12 and the lower pull strap 15 is slightly less than that of the upper surface layer 11 and the lower surface layer 16, such that a determined distance is defined between the periphery 17 of the air cushion structure 10, the upper pull strap 12, and the lower pull strap 15, and forms an air inlet channel 18. In such a manner, when the air is filled with the air cushion structure 10, the air cushion structure 10 forms the upper air chambers 20, the lower air chambers 30, and the middle air chambers 40 to provide multiple air chambers.

Thus, when cold air on the ground is introduced from the lower surface layer 16 toward the upper surface layer 11, the air contained in the upper air chambers 20 and the lower air chambers 30 provides a block to the cold air, thereby preventing the cold air from directly touching the user, so as to achieve a warming effect. In addition, the middle air chambers 40 also obstructs the cold air, while the upper isolating layer 13 and the lower isolating layer 14 provide an isolating effect, thereby preventing the cold air from directly touching the user, so as to achieve a warming effect. Further, the air cushion structure 10 contains multiple air chambers to distribute the pressure evenly, thereby providing a better support, and thereby providing a comfortable sensation to the user.

Accordingly, the air cushion structure 10 constructs multiple air chambers by provision of the upper pull strap 12 and the lower pull strap 15 and by provision of the upper isolating layer 13 and the lower isolating layer 14, to provide obstruction and isolation functions, thereby preventing the cold air from directly touching the user, so as to achieve a warming effect efficiently. In addition, the air cushion structure 10 contains multiple air chambers so that when the user lies on the air cushion structure 10, the multiple air chambers distribute the pressure evenly, so as to provide a better support, and to provide a comfortable sensation to the user.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An air cushion structure comprising:
an upper surface layer, an upper pull strap, an upper isolating layer, a lower isolating layer, a lower pull strap, and a lower surface layer;
wherein:
the upper surface layer is provided with a plurality of upper adhering points which are equally distant from each other;
the upper surface layer is provided with an air valve;
the upper pull strap is mounted on a bottom of the upper surface layer;
the upper pull strap is provided with a plurality of first adhering points and a plurality of second adhering points;
the first adhering points are equally distant from each other;
the second adhering points are equally distant from each other;
the upper isolating layer is mounted on a bottom of the upper pull strap;
the upper isolating layer is provided with a plurality of third adhering points and a plurality of upper perforations;
the lower isolating layer is mounted on a bottom of the upper isolating layer;
the lower isolating layer has a bottom provided with a plurality of fourth adhering points;
the lower isolating layer is provided with a plurality of lower perforations;
the lower pull strap is mounted on a bottom of the lower isolating layer;
the lower pull strap is provided with a plurality of fifth adhering points and a plurality of sixth adhering points;
the fifth adhering points are equally distant from each other;
the sixth adhering points are equally distant from each other;
the lower surface layer is mounted on a bottom of the lower pull strap; and
the lower surface layer is provided with a plurality of lower adhering points which are equally distant from each other.

2. The air cushion structure as claimed in claim 1, wherein the upper pull strap and the lower pull strap have an equal length and an equal width.

3. The air cushion structure as claimed in claim 2, wherein the length and width of the upper pull strap is less than that of the upper surface layer and that of the lower surface layer, and the length and width of the lower pull strap is less than that of the upper surface layer and that of the lower surface layer.

4. The air cushion structure as claimed in claim 1, wherein the upper adhering points of the upper surface layer, the first adhering points of the upper pull strap, and the third adhering points of the upper isolating layer correspond to each other and are connected together.

5. The air cushion structure as claimed in claim 1, wherein the upper isolating layer and the lower isolating layer are disconnected when being heated.

6. The air cushion structure as claimed in claim 1, wherein:
the second adhering points of the upper pull strap, the upper perforations of the upper isolating layer, the lower perforations of the lower isolating layer, and the sixth adhering points of the lower pull strap correspond to each other; and
the second adhering points of the upper pull strap and the sixth adhering points of the lower pull strap are connected together.

7. The air cushion structure as claimed in claim 1, wherein the fourth adhering points of the lower isolating layer, the fifth adhering points of the lower pull strap, and the lower adhering points of the lower surface layer correspond to each other and are connected together.

8. The air cushion structure as claimed in claim 1, wherein the upper surface layer and the lower surface layer have an equal length and an equal width.

9. The air cushion structure as claimed in claim 1, wherein the bottom of the upper surface layer is provided with an air impermeable plastic film that is made of thermoplastic polyurethane (TPU), the upper pull strap is a plastic film that is made of thermoplastic polyurethane (TPU), the lower pull strap is a plastic film that is made of thermoplastic polyurethane (TPU), and the lower surface layer has a top provided with an air impermeable plastic film that is made of thermoplastic polyurethane (TPU).
